(19) United States
(12) Patent Application Publication
(10) Pub. No.: US 2013/0238437 A1
(43) Pub. Date: Sep. 12, 2013

(54) VARIABLE KEYWORD BIDDING BASED ON SEARCH RESULTS POSITION

(71) Applicants: Rahul Nair, Daly City, CA (US); Simon P. King, Berkeley, CA (US); Marc Eliot Davis, San Francisco, CA (US)

(72) Inventors: Rahul Nair, Daly City, CA (US); Simon P. King, Berkeley, CA (US); Marc Eliot Davis, San Francisco, CA (US)

(73) Assignee: MICROSOFT CORPORATION, Redmond, WA (US)

(21) Appl. No.: 13/418,126

(22) Filed: Mar. 12, 2012

(51) Int. Cl. G06Q 30/02

(52) U.S. Cl. 705/14.54

(57) ABSTRACT

Embodiments for providing a search results page that includes at least one advertisement responsive to a search request are presented. A search request is received from a user. The search request is associated with a query term upon which advertisers have bid. A set of search results is obtained responsive to the search request. Bids from multiple advertisers are identified. Identifying bids from advertisers includes dynamically determining a present bid amount of a first bid according to the position of a search result in the set of search results. After determining the bid value of each bid, a winning bid is selected from the identified bids. A search result page is generated a portion of the search results and the advertisement corresponding to the selected bid. The generated search results page is returned to the user for display responsive to the search request.

### BACKGROUND

The standard practice for keyword advertising with a search engine is for an advertiser to bid on a particular keyword or set of keywords. The purpose of the bidding is to place an advertisement on a search results page that the search engine generates in response to a search request pertaining to the bid-upon keyword or keywords. Thus, when the search engine receives a search request that pertains to the keyword(s) upon which advertisers have bid, the search engine selects a bid from the various advertisers' bids. The search engine selects the winning bid according to what it believes will provide the greatest return (determined as a function of the bid price and expected performance of the corresponding advertisement.) In this scenario, bidding on keywords occurs before any search request has been received by the search engine.

Bidding on keywords can be very expensive for an advertiser. Accordingly, advertisers take advantage of all of the tools and information available to determine an appropriate strategy for bidding on keywords. One of the strategies that advertisers have used is to evaluate where their “links” will typically be placed in a search results page for a given search request. An advertiser that bids on a particular keyword will often have one or more search results referencing content on its own webpage for a search request on the particular keyword. For example, a search results page responsive to a search request for “hard drives” may include one or more search results referencing a hard drive manufacturer. Of course, given the subject matter, “hard drives,” that same hard drive manufacturer may wish to advertise its products on search results pages responsive to a search request for hard drives. Hence, that hard drive manufacturer will bid on the keyword phrase “hard drives” to advertise the manufacturer's products, with the result being that the hard drive manufacturer advertises on the same search results page that includes search results referencing the hard drive manufacturer's products. Accordingly, an advertiser will factor in the projected position of search results referencing the advertiser's own content in determining a bidding strategy for a given keyword.

Those skilled in the art will appreciate that position among search results is extremely important. The first three search results displayed on the first page of search results are far more likely to be selected by a user than any other search results. Similarly, search results that are placed “above the fold” (the “fold” being that position in a search results page, as displayed in the user's browser, where search results are not visible when the page is initially displayed) are more likely to be selected by a user than results below the fold. In order to maximize their return on investment (ROI), advertisers will often bid different amounts depending on search results position. For example, an advertiser may bid lower for a keyword if the search results pointing to the advertiser's content are placed in prominent positions (first three results, above the fold, on the first search results page, etc.) in the search results set. Conversely, an advertiser may bid higher for the keyword if the search results pointing to the advertiser are placed in a less prominent position in the search results set.

Factoring in the position of search results pointing to the advertiser when determining a bid for keyword works well as a strategy so long as the search results position can be accurately determined. However, search engines are now beginning to customize and/or personalize search results to the users. With customization/personalization of search results, the position of a search result in a set of search results varies greatly between users for the same query. For example, if the query is “jaguar”, the search results for an avid football fan might be entirely different than the search results for a fan of British cars, or for a fan of large wild cats. With customization/personalization of search results, advertisers have lost the ability factor in the position of search results that reference the advertiser when bidding on keywords.

### SUMMARY

According to at least one embodiment of the disclosed subject matter, a method enabling advertisers to condition the value of a bid for a search request term according to the position of search results referencing themselves is presented. Responsive to a search query, a plurality of bids from a plurality of advertisers corresponding to the query term is identified. Identifying the plurality of bids from the plurality of advertisers includes dynamically determining a present bid amount for at least a first bid from a first advertiser as a function of the position of a search result referencing content associated with the first advertiser in the set of search results. After identifying the plurality of bids and dynamically determining the value of the at least first bid, a winning bid is selected. A search results page is generated from the initial set of search results, the search results page including the advertisement corresponding to the winning bid. Thereafter, the generated search results page is returned responsive to the search request.

A computer-implemented system for dynamically selecting an advertisement for inclusion in a search results page is also presented. The computer-implemented system comprises a search results retrieval component for retrieving a set of search results in response to a search request. In response to the search request, the system identifies a plurality of bids from a plurality of advertisers corresponding to a query term in the search request and dynamically determines a present bid amount for each of the plurality of bids. At least one bid of the plurality of bids is a variable bid whose present bid amount is determined according to the position of a search result in the set of search results. The system selects a winning bid of the plurality of bids according to the determined present bid amount of each bid and generates a search results page from the set of search results. The generated search results page includes an advertisement corresponding to the selected winning bid. This search results page generator component returns a first search results page to the user in response to the search request.

In an alternative embodiment of the disclosed subject matter, a computer-readable medium bearing computer-executable instructions is also presented. The instructions carry out the following, including obtaining a plurality of bids for a query term from a plurality of advertises. The plurality of bids includes at least one bid from an advertiser whose present bid amount is indeterminate without identifying a position of a search result in the set of search results. A set of search results is obtained corresponding to a search request for the query term. The order of the search results in the set of search results is rearranged according to at least one preference associated with a user and the bid amounts of the plurality of bids are dynamically determined. A winning bid from the plurality of bids is selected. A search result page that includes an advertisement corresponding to the selected bid is generated and returned to the user responsive to the search request.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram of an exemplary networking environment suitable for implementing variable keyword bidding based on search results position;

FIG. 2 is a diagram illustrating exemplary components of a search engine 110 as configured to accept bids from advertisers, including variable bids based on the position of a search result referencing the advertiser, and receive and respond to search requests from users with search result pages that include at least one advertisement;

FIG. 3 is a diagram of an illustrative table of bids from a plurality of advertisers corresponding to a search query term;

FIG. 4 is a diagram of an illustrative table showing elements of an exemplary variable bid as may be received from an advertiser;

FIG. 5 is a flow diagram of a routine for responding to a user's search request with a search results page according to novel aspects of the disclosed subject matter; and

FIG. 6 is a flow diagram of a subroutine, suitable for use by the routine of FIG. 5, in dynamically determining the present value of each bid from a plurality of advertisers according to the position of a search result.

### DETAILED DESCRIPTION

For purposes of clarity, the use of the term “exemplary” in this document should be interpreted as serving as an illustration or example of something, and it should not be interpreted as an ideal and/or leading illustration of that thing. Additionally, the remainder of this document will use “query term” or “search query term” when referring to a keyword, keywords, concept, or entity upon which an advertiser may bid. For example, “hard drives,” as used in the example above, is a query term. Similarly, “jaguar” is a query term, as is “2012 presidential race.”

For purposes of clarity and as used throughout this document, a “variable bid” should be interpreted as a bid from an advertiser to place an advertisement on a search results page responsive to a search request associated with a query term. The “variable” part of the bid is that the bid amount cannot be determined (i.e., it is indeterminate) without knowing the position of a search result in a search results set. Frequently, but not exclusively, the search result references content associated with, or from, the advertiser submitting the variable bid. In other words, the bid is variable based on the position of a search result in a search results set responsive to a search request from a user. As has been discussed above, the position of the search result in a search results set cannot be predicted by an advertiser at the time of submitting a bid (including a variable bid) since the order of search results in a search results set vary widely according to the user submitting the search request. A “present bid amount” is the value of a bid, determined as a function of the position of a search result in a set of search results responsive to a search request from a user.

With regard to the phrases “referencing content from an advertiser” or “referencing content from a third party”, it should be understood that the referenced content may be a specific item, a specific set of items, or an entire domain. For example, a variable bid from Company A may be conditioned on the position of a search result that references any item within Company A's domain (or domains). Alternatively, a variable bid from Company B may be condition on the position of a search result that references a specific item available from Company B. Still further, a variable bid from Company C may be condition on the position of a search result that references any one of a set of items offered by Company D (a third party to Company C).

A set of search results obtained by a search engine in response to a search request are presented to the user in a series of search results pages. Each search results page includes a subset of the set of search results. While the number of search results on a search results page can be configured, typically the number of search results on a search results page is 10, and are often referred to as the “10 blue links” (since the hyperlinks to the referenced content are displayed in blue.) Irrespective of the number of search results on a search results page, a user's browser is generally unable to display all of the search results of a search results page to the user via at the same time. Instead, the user must use various user controls to scroll up and down on the search results page in order to see all of the search results on the page. Those search results in a search results page that are initially visible to the user in the user's browser are important as studies have shown that users highly favor (act upon) those first results. The search results of a search results page that are initially visible to the user are said to be displayed “above the fold,” whereas the search results of a search results page that are not initially visible are said to be displayed “below the fold.” The actual location of the “fold,” i.e., the place in the search results page where the search results are not initially visible to the user, is highly specific to the current configuration of the user's browser. Browser configuration information is available at the time that the search engine fields a search request from a user, but is not available (or is not reliable) at the time that an advertiser bids on a query term. Hence, even without customizing search results to a specific user, predicted position information is largely specious prior to receiving a search request.

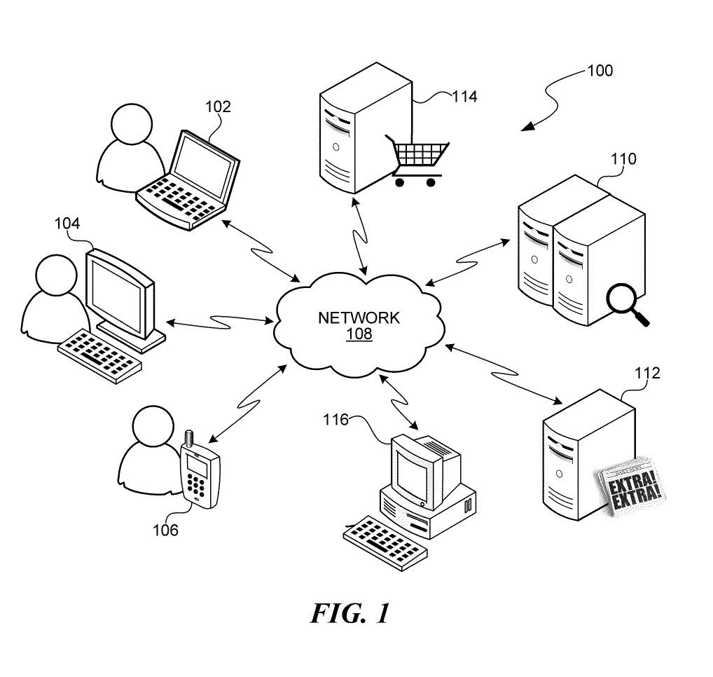

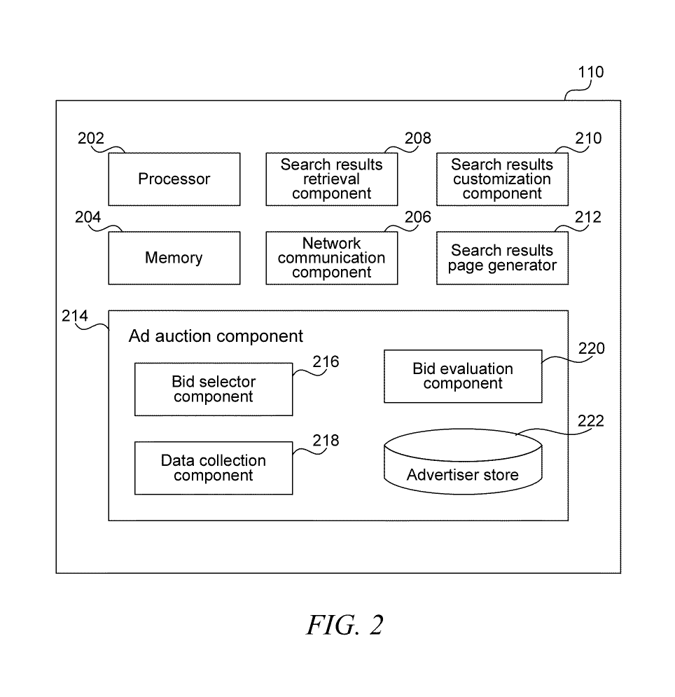

Turning now to the figures, FIG. 1 is a diagram of an exemplary networking environment 100 suitable for implementing variable keyword bidding based on search results position. As shown, the illustrative environment 100 includes one or more user computers, such as user computers 102-106, connected to a network 108, such as the Internet, a wide area network or WAN, and the like. Also connected to the network 108 is a search engine 110 suitably configured to implement variable keyword bidding based on search results position and advertisement selection in response to search requests received from users, such as the users connected to user computers 102-106. Aspects of the search engine 110 are described in greater detail below in regard to FIG. 2.

Further connected to the network 108 are one or more advertiser computer systems 112-116. The advertiser computer systems correspond to the online presence of a plurality of advertisers, such as a news service 112, an online shopping service 114, and a home repair service 116. For the purposes of simplicity in the presentation of the disclosed subject matter, unless explicitly described otherwise, an advertiser, the advertiser's online presence, and the advertiser's computing device (or devices) will be treated as synonymous. Hence, the exemplary networking environment 100 includes a plurality of advertisers, including (but not limited to) the news service 112, the online shopping service 114, and the home repair service 116.

As those skilled in the art will appreciate, suitable user computers for operating in the illustrative environment 100 include any number of computing devices that can communicate with the search engine 110 over the network 108 in both submitting search requests and receiving a response of search results page from the search engine 110. User computers 102-106 may communicate with the network 108 via wired or wireless communication connections. These user computers 102-106 may include, but are not limited to, laptop computers such as user computer 102, desktop computers such as user computer 104, mobile phone devices such as user computer 106, tablet computers (not shown), on-board computing systems (not shown)such as those found in vehicles, mini- and/or main-frame computers (not shown), and the like. As those skilled in the art will appreciate, at their base, the user computers 102-106 are comprised of a processor and a memory, where the processor executes instructions retrieved from the memory to carry out various functions. The user computers 102-106 of the illustrative environment 100 also include a communications component (not shown) that enables the computers to send search requests to the search engine 110 and, in response, receive search results for presentation to the corresponding user.

Regarding the search engine 110, those skilled in the art will appreciate that a search engine corresponds to an online service hosted on one or more computers. In the case of multiple computers, the computers may be tightly or loosely coupled and/or distributed throughout the network 108. The illustrated search engine 110, as shown in FIG. 1, comprises two computing devices but this should be viewed as illustrative only. The online search service hosted by search engine 110 (simply referred to as the “search engine” throughout this document) receives search requests from user computers 102-106 over the network 108 and, in response to each request, identifies a set of search results (i.e., references to content) that are relevant to the request. The search engine 110 generates at least one search results page (and often many pages) for presentation to the user based on the identified set of search results, and returns at least the first search results page to the requesting user. The search engine 110 also includes or is closely associated with an ad auction service with which advertisers, such as advertisers 112-116, can bid on query terms with the intent to place corresponding advertisements on the search results pages.

While FIG. 1 is described in regard to a variety of computers, components and advertisers, those skilled in the art will appreciate that in an actual embodiment, there are likely numerous advertisers (including shopping sites, news organizations, service shops, and other entities), services and users connected to the network 108 and the search engine 110. The search engine 110 is informed of, or crawls, numerous sites in an effort to identify and index the available content and its source such that the content can be served to users in response to search requests.

Turning now to FIG. 2, this figure shows a diagram illustrating exemplary components of the search engine 110 as configured to accept bids from advertisers, including variable bids based on the position of a search result in a set of search results, and receive and respond to search requests from users with search result pages that include at least one advertisement.

The search engine 110 includes a processor 202 and a memory 204. As those skilled in the art will appreciate, the processor 202 executes instructions retrieved from memory 204 in carrying out various aspects of the search service as part of, or in conjunction with, various components described hereafter. The search engine 110 also includes a network communications component 206 through which the search engine sends and receives communications over the network 108. For example, it is through the network communication component 206 that the search engine 110 receives search requests from user computers, such as user computers 102-106, and returns results responsive to the search requests. Moreover, it is through the network communication component 206 that the search engine 110 communicates with advertisers in conducting an ad auction including enabling an advertiser to submit a variable bid based on the position of search results.

The search engine 110 further includes a search results retrieval component 208, a search results customization component 210, a search results page generator 212, and an ad auction component 214. The search results retrieval component 208 retrieves a set of search results from a content index (not shown) in response to a user's search request. The set of search results may then be customized and/or personalized for the user by the search results customization component 210. These customizations may be based on implicit and/or explicit preferences associated with the user submitting the search request, the user's browsing history, social network, purchase history, geographic context, and the like. As discussed earlier, due to the customization/personalization of search results to the user, the location of any one search result in a set of search results varies widely between users. After the set of search results has been customized/personalized, the search results page generator 212 generates one or more search results pages from the customized set of search results. In addition to including search results in each generated search results page, the search results page generator also includes an advertisement in the search results page. The advertisement included in the generated search results page is selected by the ad auction component 214.

The ad auction component 214 is shown in FIG. 2 as being part of the search engine 110. In an actual embodiment, the ad auction component 214 may be a separate component from the search engine 110. However, due to the close cooperation between a search engine 110 and an ad auction component 214, these two “services” may be viewed as a single, logical hosted service, as shown in FIG. 2. Hence, while FIG. 2 illustrates that the ad auction component 214 is a part of the search engine 110, this should be viewed as illustrative of one particular, non-limiting embodiment of the disclosed subject matter.

The ad auction component 214 conducts the auction of query terms and the selection of winning bids for inclusion in search results pages. As illustrated in FIG. 2, the ad auction component 214 includes a bid selector component 216, a bid evaluation component 220, a data collection component 218, and an advertiser store 222. The advertiser store 222 stores the bids corresponding to query terms from a plurality of advertisers. These bids are associated with advertisements (optionally stored in the advertiser store 222) such that when a winning bid is selected by the bid selector component 216 the advertisement corresponding to that selected bid is placed in the search results page as generated by the search results page generator 212. When a bid has been selected, information regarding that selection is recorded by the bid evaluation component 220. When the selected bid is a variable bid based on the position of a search result referencing the corresponding advertiser, the recorded information will typically include, but not be limited to, the dynamically determined value of the bid as well as the position of the search result referencing the advertiser in the search result set.

According to novel aspects of the disclosed subject matter the search engine 110 (via the ad auction component 214) allows advertisers to submit variable bids based on the position of one or more search results in the set of search results, typically search results that reference content corresponding to the advertiser. Because the actual position of a search results is not determined until after the customization/personalization of the set of search results, the value of a variable bid cannot be determined until after customization and before generating the search results pages. The ad auction component 214 dynamically determines the bid value of the variable bid via the bid evaluation component 220. This is quite unlike typical search engine/add auction services where the value of the bid is determined at the time that the advertiser submits a bid regarding a query term.

While various components of a search engine 110 have been described above, including an ad auction component 214 and its subcomponents, it should be appreciated that these are logical components, not necessarily actual components. These components are presented for describing aspects of the disclosed subject matter. Those skilled in the art will appreciate that, in an actual embodiment, the functionality of these logical components may be implemented as illustrated in FIG. 2, subdivided into various other components, and/or combined into any number of actual components. Accordingly, the particular logical arrangement of components of the search engine 110, as shown in FIG. 2, should be viewed as illustrative only and not limiting upon the disclosed subject matter.

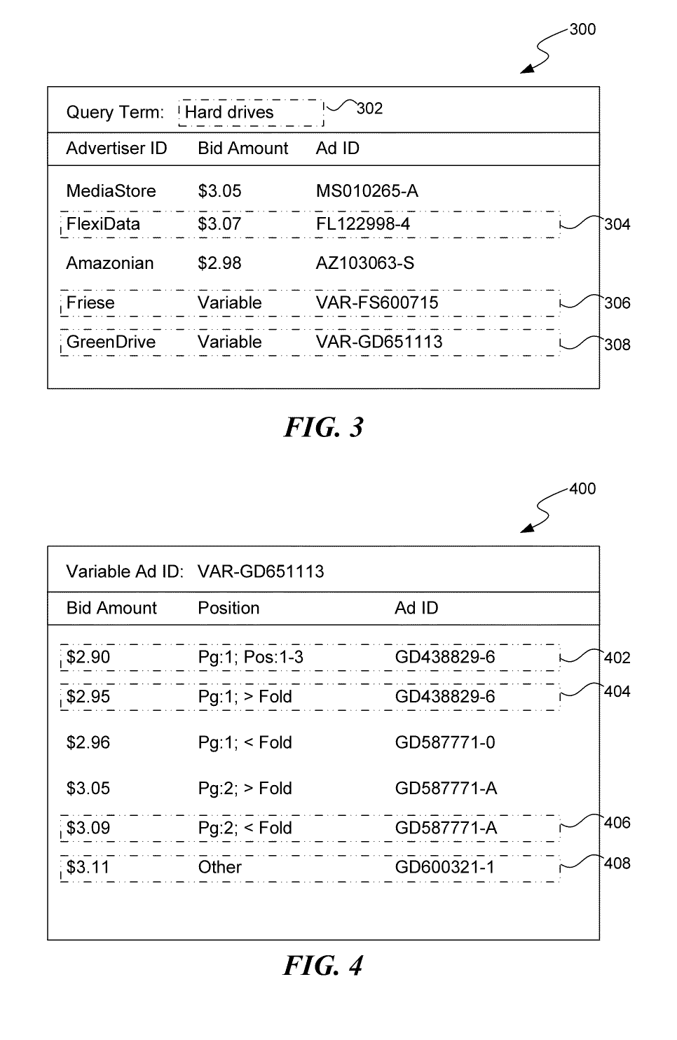

Turning now to an examination of variable bids, FIG. 3 is a diagram of an illustrative table 300 of bids corresponding to a search query term from a plurality of advertisers. As shown in table 300, the query term 302 for which various advertisers have bid is “Hard drives.” In this example, table 300 illustrates that advertiser bids are associated with at least three pieces of information: an advertiser ID, a bid amount, and an advertisement ID/reference associating the bid with the actual advertisement that would be displayed in a generated search results page. This table 300 includes both static bids (bids from advertisers where the bid amount is fixed) such as bid 304, as well as variable bids, including bid 306 and bid 308. According to the information in table 300, when a search request associated with the query term “hard drives” is received, the bid evaluation component 220 of the ad auction component 214 dynamically determines the present value of the variable bids 306 and 308.

Turning then to FIG. 4, this figure depicts a diagram of an illustrative table 400 showing elements of an exemplary variable bid. For purposes of this example reference is made to variable bid 308 of FIG. 3. As can be seen in table 400, bid elements of variable bid 308 include a bid amount, a position, and an advertisement ID/reference. As can be seen, each defined bid amount is associated with a particular search results position, i.e., an indication of the position of a search result in a search results page. For bid element 402, when the search result is found on the first search results page of a set of search results (as indicated by “Pg:1”) and is located on the search results page as one of the first three search results (as indicated by “Pos: 1-3”) then the bid amount is “$2.90.” Similarly, for bid element 404, when the search result is found on the first search result page of a set of search results and the search result is displayed “above the fold” (as indicated by “>Fold”), then the bid amount for the variable bid 308 would be “$2.95.” For bid element 406, if the search result is found on the second page of a set of search results and is displayed “below the fold” then the variable bid amount would be “$3.09.” Of interest to note is bid element 408 where another token “Other” is used to depict the placement of the search results in locations other than those specifically called out in the other bid elements for the variable bid 308. In this case, the value of the variable bid 308 would be “$3.11” if the search result is not placed in any of the search result positions otherwise identified. Also of interest is the fact that a variable bid may be associated with more than one advertisement. While the advertisement (as referenced by Ad ID “GD438829-6”) for bid elements 402 and 404 are the same, bid elements 406 and 408 reference other advertisements.

One may notice that the bid value of the variable bid 308 increases as the position of a search result in a set of search results becomes less desirable. While this may seem counterintuitive, in fact this an anticipated practice of advertisers. It is anticipated that if a search result referencing content to an advertiser is placed in a prominent position in the set of search results, such as in one of the first three positions on the first search results page (as shown in bid element 402), the likelihood that the user will select or act upon that search results is quite high. Thus, given the likelihood that a user will select the search result, the advertiser will have less incentive to place an advertisement on the search results page. Conversely, if the advertisers search results is not placed in a position of prominence in the set of search results, as signified by bid element 408, then the advertiser has a greater incentive to place an advertisement on a first search results page. Hence, it is anticipated that as the position of a search result referencing content associated with an advertiser decreases in prominence, the price that an advertiser may be willing to pay to place an advertisement on a search results page increases.

While table 400 shows variable bid 308 as having multiple bid elements, including bid elements 402-408, where each bid element has a discrete bid amount corresponding to a search result position in a set of search results, it should be appreciated that this is a non-limiting example of a variable bid. While not shown, a variable bid may be expressed in regard to one or more continuous functions. For example, the bid amount for variable bid 306 may be determined as a function of the distance from the first search result in a set of search results, in terms of the search result position on a search results page, the search results page number, a combination of the two, a combination of the search result position with regard to a second search result, as an expression of the position of a search result of another party, and the like.

With regard to tables 300 and 400, it should be appreciated that these tables are set forth to illustrate basic features involved with variable bids. It should be appreciated that in an actual embodiment, organization of advertiser bids as well as the organization of variables bids are not constrained to the format shown. Moreover, additional information may be included with advertiser bids as well as variable bids. According, these tables should be view as illustrative and non-limiting embodiments of the disclosed subject matter.

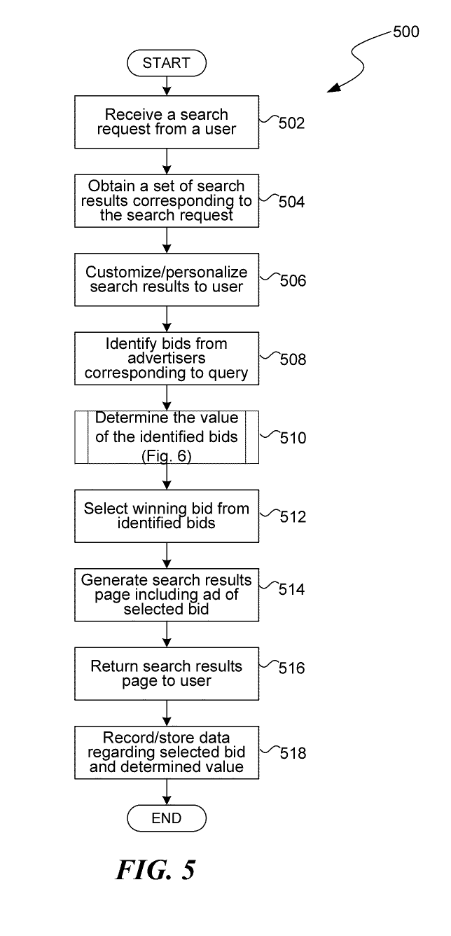

Turning now to FIG. 5, this figure depicts a flow diagram of a routine 500 suitable for responding to a user's search request with a search results page according to novel aspects of the disclosed subject matter. Beginning at block 502 of routine 500, a search request is received. At block 504, a set of search results corresponding to the search request is obtained. At block 506, the set of search results is customized/personalized according to the user submitting the search request. Customizing/personalizing the set of search results has the effect of rearranging the order of the search results in the search result set. As has been mentioned, the search result set is customized to the user according to any number of user preferences (both implicit and explicit preferences) including the user's browsing history, preferences of the user's social network, the user's likes/dislikes, the user's purchase history, the user's current geographic location, and the like.

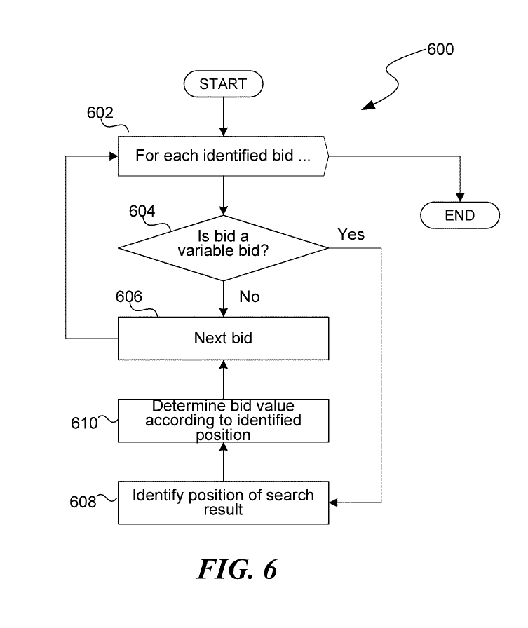

At block 508, the bids from a plurality of advertisers corresponding to a query term associated with the search request are identified. At block 510, the present bid value of the identified bids from the plurality of advertisers is determined. Determining the present value of the identified bids is presented in greater detail with regard to FIG. 6.

Turning to FIG. 6, this figure illustrates a flow diagram of a subroutine 600, suitable for use by routine 500 of FIG. 5, in dynamically determining the present bid value of the plurality of bids from the plurality of advertisers according to the position of a search result in a search result set. Beginning at control block 602, a looping construct is initiated to iterate through each identified bid. Beginning with the first bid, subroutine 600 moves to decision block 604 where a determination is made as to whether the current bid is a variable or static bid. If at decision block 604 the bid is a static bid, then the value of the bid is already set (at the time the advertiser submitted the bid) and the subroutine 600 proceeds to block 606. At block 606, the looping construct iterates to the next bid of the identified bids and the subroutine 600 returns to control block 602 to repeat the process.

If, at decision block 604, the bid is determined to be a variable bid, subroutine 600 proceeds to block 608. At block 608 the position of the search result is identified. In some instances this search result is one that references content corresponding to the advertiser (the advertiser that submitted the particular bid.) However, in an alternative embodiment an advertiser may wish to condition its variable bid according to the position of a search result referencing content to a third party, such as a competitor. Further still, an advertiser may wish to condition its variable bid according to the relative position of the search result referencing content of the advertiser with regard to a search result referencing content of another party (such as a competitor.) As can be seen, an advertiser's variable bid can be configured in any number of ways with regard to the position of a search result referencing content from the advertiser in a set of search results, the position of a search result referencing content from one or more third parties, or any combination of both. Accordingly, at block 610 the bid value of the variable bid is determined according to the position of a search result as would be defined in the variable bid. Determining the bid value comprises evaluating the position of the search result (or results) with regard to the criteria specified in the variable bid.

After determining the present bid value, subroutine 600 proceeds to block 606, as described above, where the looping construct iterates to the next bid (if there is another bid to evaluate). Subroutine 600 returns to control block 602 where the process repeats if there is at least another bid to evaluate. When, at control block 602, there are no more bids to be evaluated, subroutine 600 terminates.

Returning again to FIG. 5, after determining the value of the identified bids, routine 500 proceeds to block 512 where a winning bid is selected from the identified bids. It should be appreciated that selecting a winning bid from the identified bids is not necessarily based solely on the highest bid amount of the identified bids. Search engines, such as search engine 110, select winning bids based on bid amount as well as the predicted performance of the corresponding advertisement, fulfillment goals of one or more advertisement campaigns, and the like. After selecting a winning bid, at block 514 a search results page is generated from a portion of the set of search results and that also includes the advertisement corresponding to the selected winning bid. At block 516, the generated search results page is returned to the user.

In addition to returning the generated search results page to the user in response to the search request, at block 518 data regarding the selected winning bid, such as (but not limited to) the winning bid value, search result position and other information that may be useful or necessary in supporting the selection of the winning bid (such as the user context and the like), is stored by the search engine 110. Thus, after having responded to the user's search request with a search results page that includes an advertisement corresponding to the winning bid, and after having stored the relevant data regarding the context in which the winning bid was selected, the routine 500 terminates.

Regarding FIGS. 5 and 6, it should be appreciated that while routines 500 and 600 are expressed with discrete steps, these steps should be viewed as being logical in nature and may or may not correspond directly to any actual, discrete steps. Those skilled in the art will appreciate that logical steps may be combined together or be comprised of multiple steps. Further, while novel functionality of the disclosed subject matter has been expressed in regard to routines or methods, this functionality may also be embodied in computer-readable media. As those skilled in the art will appreciate, computer-readable media hosts computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage hosting service; and the like. For purposes of this document, however, computer-readable media expressly excludes carrier waves and propagated signals.

While various novel aspects of the disclosed subject matter have been described, it should be appreciated that these aspects are exemplary and illustrative, and should not be construed as limiting upon the disclosed subject matter. Variations and alterations to the various aspects may be made without departing from the scope of the disclosed subject matter.

What is claimed:

1. A computer-implemented method for providing a search results page including at least one advertisement responsive to a search request, the method comprising:
receiving a search request;
obtaining a set of search results responsive to the search request;
identifying a plurality of bids from a plurality of advertisers, each bid to place an advertisement on a search results page responsive to the search request, wherein identifying bids from advertisers includes dynamically determining a present bid amount of a first bid from a first advertiser according to the position of a search result referencing content associated with the first advertiser in the set of search results;
selecting a bid from the identified bids;
generating a search result page that includes the advertisement corresponding to the selected bid; and
returning the generated search results page for display responsive to the search request.

2. The method of claim 1, wherein the first bid from the first advertiser comprises a plurality of bid amounts, each bid amount corresponding to a position in the set of search results such that the present bid amount for the first bid is the bid amount corresponding to the position in the set of search results where the search result referencing content associated with the first advertiser is found.

3. The method of claim 2, wherein the position in the set of search results comprises a search results page number and a search results page position.

4. The method of claim 3, wherein the search results page position comprises an indication that the search result referencing content associated with the first advertiser is above the fold in a search results page or below the fold in a search results page.

5. The method of claim 1, wherein the present bid amount of the first bid from the first advertiser is further determined according to which page of a plurality of search result pages the search result referencing content associated with the first advertiser is found.

6. The method of claim 1 further comprising rearranging the order of the search results in the set of search results according to preferences of the user.

7. A computer-implemented system for dynamically selecting an advertisement for inclusion in a search results page in response to a search request received from a user, the system comprising:
a processor and a memory, wherein the processor is configured to execute instructions retrieved from the memory in dynamically selecting an advertisement for inclusion in a search results page in response to a search request received from a user;
a network component for communicating with a plurality of advertisers and users, including the user, over a network;
a search results retrieval component for retrieving a set of search results in response to receiving the search request from the user;
an ad auction component that:
identifies a plurality of bids from a plurality of advertisers corresponding to a query term in the search request,
dynamically determines a present bid amount for each of the plurality of bids, wherein at least a first bid of the plurality of bids is a variable bid whose present bid amount is determined according to the position of a first search result in the set of search results responsive to the search request, and
selects a winning bid of the plurality of bids according to the determined present bid amount of each bid; and
a search results page generator component that generates a search results page from the set of search results, the search results page including an advertisement corresponding to the selected winning bid, and returns the search results page to the user in response to the search request.

8. The computer-implemented system of claim 7 further comprising a customizing component that rearranges the order of the search results in the set of search results according to preferences associated with the user, and wherein the ad auction component dynamically determines the present bid amount of the first bid according to the position of the first search result in the rearranged set of search results.

9. The computer-implemented system of claim 8, wherein the variable bid is from a first advertiser, and wherein the first search result references content associated with the first advertiser.

10. The computer-implemented system of claim 9, wherein the ad auction component determines the present bid amount of the variable bid according to the position in the set of search results of the first search result that references content associated with the first advertiser relative to the position of a second search result that references content associated with a third party.

11. The computer-implemented system of claim 8, wherein the variable bid is from a first advertiser, and wherein the first search result references content associated with a third party.

12. The computer-implemented system of claim 8, wherein the variable bid is from a first advertiser and comprises a plurality of bid amounts, each bid amount corresponding to a position in the set of search results such that the present bid amount for the first bid is the bid amount corresponding to the position in the set of search results where the first search result referencing content associated with the first advertiser is found.

13. The computer-implemented system of claim 7, wherein the variable bid is from a first advertiser and comprises a plurality of bid amounts, each bid amount corresponding to a position in the set of search results such that the present bid amount for the first bid is the bid amount corresponding to the position in the set of search results where the first search result referencing content associated with the first advertiser is found.

14. The computer-implemented system of claim 13, wherein the position in the set of search results comprises a search results page number and a search results page position.

15. The computer-implemented system of claim 14, wherein the search results page position comprises an indication that the search result referencing content associated with the first advertiser is above the fold in a search results page or below the fold in a search results page.

16. The computer-implemented system of claim 8, wherein the present bid amount of the first bid is further determined according to the page of a plurality of search result pages on which the first search result is found.

17. A computer-readable medium bearing computer-executable instructions which, when executed on a computing device comprising at least a processor and a memory, carry out a method comprising:
obtaining a plurality of bids for a query term from a plurality of advertises, each bid to place an advertisement on a search results page responsive to a search request associated with the query term, the plurality of bids including at least a first bid from a first advertiser whose present bid amount is indeterminate without identifying a position of a first search result in the set of search results;
receiving a search request from a user associated with the query term;
obtaining a set of search results corresponding to the query term;
rearranging the order of the search results in the set of search results according to at least one preference associated with the user;
dynamically determining the bid amounts of the plurality of bids, wherein dynamically determining the bid amounts of the plurality of bids includes determining a bid amount for the first bid from the first advertiser as a function of the position of the first search result in the rearranged set of search results;
selecting a winning bid from the plurality of bids;
generating a search result page that includes an advertisement corresponding to the selected bid;
returning the generated search results page to the user responsive to the search request.

18. The computer-readable medium of claim 17, wherein the first search result references content associated with the first advertiser.

19. The computer-readable medium of claim 17, wherein the first search result references content associated with a third party.

20. The computer-readable medium of claim 17, wherein the position of the first search result in the rearranged set of search results comprises a search results page number and a search results page position.
